(19) United States
(12) Patent Application Publication
(10) Pub. No.: US 2017/0259091 A1
(43) Pub. Date: Sep. 14, 2017

(54) FIRE-FIGHTING SYSTEM

(71) Applicant: OFB Fire Solutions Pty Ltd, Queensland (AU)

(72) Inventor: Michael Bruce Harvey, Queensland (AU)

(21) Appl. No.: 15/529,844

(22) PCT Filed: Nov. 27, 2015
(86) PCT No.: PCT/AU2015/050750

§ 371 Date: May 25, 2017

(30) Foreign Application Priority Data
Nov. 28, 2014 (AU) 2014904835

(51) Int. Cl. A62C 5/02; A62C 31/12; B01F 5/06; B05B 7/00; B01F 3/04; A62C 13/66; A62C 35/02

(52) U.S. Cl. CPC A62C 5/02; A62C 13/66; A62C 31/12; A62C 35/023; B05B 7/0031; B01F 3/04446; B01F 5/0615; B01F 5/0693; B01F 2005/0097

(57) ABSTRACT

A fire-fighting system including: a pressurized gas supply; a vessel for storing a solution of water and a foaming agent, the vessel being connected to the pressurized gas supply for pressurizing the vessel in use; and a mixer for mixing gas from the pressurized gas supply with the solution to generate foam, wherein the mixer includes: a solution inlet for receiving the solution from the vessel; a foam outlet; one or more injection ports connected to the pressurized gas supply for injecting gas bubbles into the solution to form a mixture of the solution and the gas bubbles; and a foaming chamber extending between the solution inlet and the foam outlet, the mixture flowing through the foaming chamber to generate foam at the foam outlet, at least one internal surface of the foaming chamber including a shearing structure for shearing the gas bubbles as the mixture flows through the foaming chamber.

### BACKGROUND OF THE INVENTION

The present invention relates to a fire-fighting system, being particularly suitable for use in an air injected foam system type of fire-fighting system.

### DESCRIPTION OF THE PRIOR ART

Air injected foam systems (AIFS), also known as compressed air foam systems (CAFS), have attracted considerable interest in fire-fighting applications, as these allow a small volume of water, mixed with suitable fire-fighting chemicals, to be significantly more effective on all types of fires compared to large volumes of water alone. For example, in a trial, an air injected foam fire-fighting system was able to quell a fire of 5,000 litres of aviation fuel in eighteen seconds.

Air injected foam systems generally include a water pumping system with an air injection point where compressed air is injected into a solution of water and a foam chemical to both generate foam and provide additional energy for propelling the foam beyond what would be provided by the pumping system alone. Conventional air injected foam systems typically include a foam solution source, a compressed air supply, a mixing system and a. control system for controlling the foam mixture.

U.S. Pat. No. 4,318,443 A discloses a foam generating fire fighting device which provides an apparatus for generating and discharging foam. The apparatus includes a container for receiving and storing a foam generating solution. A discharge tube is connected to container. An ejector tube is disposed within container for discharging the foam generating solution to the discharge tube. Foam generating structure is disposed between the ejector tube and the discharge tube exterior of the container and includes a chamber communicating with ejector tube for permitting the passage of the foam generating solution therethrough to the discharge tube. A pressure source communicates with the container for forcing the foam generating solution through the ejector tube and the foam generating structure. The pressure source further communicates with the chamber for aerating the foam generating solution prior to flowing through the discharge tube.

WO 2000/078400 A1 discloses a manifold for a compressed air transfer system, which is suitable for use in a compressed air foam fire-fighting system. The manifold has a fluid passage with a fluid inlet connected to a pick-up tube in a tank containing a water/chemical mixture, and a fluid outlet connectable to a hose. An air inlet is connected to a source of compressed air and an air passage directs compressed air into the fluid passage at an inclined angle to, or coaxial with, the fluid passage to promote agitation of the mixture into a foam.

However, existing air injected foam systems and compressed air foam systems do not always provide constant fine bubbled foam or allow the foam consistency to be controlled.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In a broad form the present invention seeks to provide a fire-fighting system including:
a) a pressurized gas supply;
b) a vessel for storing a solution of water and a foaming agent, the vessel being connected to the pressurized gas supply for pressurizing the vessel in use; and,
c) a mixer for mixing gas from the pressurized gas supply with the solution to generate foam, wherein the mixer includes:
   i) a solution inlet for receiving the solution from the vessel;
   ii) a foam outlet;
   iii) one or more injection ports connected to the pressurized gas supply for injecting gas bubbles into the solution to form a mixture of the solution and the gas bubbles; and,
   iv) a foaming chamber extending between the solution inlet and the foam outlet, the mixture flowing through the foaming chamber to generate foam at the foam outlet, at least one internal surface of the foaming chamber including a shearing structure for shearing the gas bubbles as the mixture flows through the foaming chamber.

Typically the shearing structure includes at least one of:
a) roughening of the at least one internal surface;
b) texturing of the at least one internal surface;
c) discontinuities formed in the at least one internal surface; and,
d) protrusions extending from the at least one internal surface.

Typically the shearing structure defines a series of sub-chambers for causing alternating compression and expansion of the mixture as the mixture flows through the sub-chambers.

Typically the shearing structure is configured to induce rotational flow of the mixture within the foaming chamber.

Typically the shearing structure is configured to change a rotation direction of the mixture as the mixture flows through the foaming chamber.

Typically the mixer includes a mixer pipe extending into the vessel, the foaming chamber being providing inside the mixer pipe.

Typically the solution inlet is provided at an open end of the mixer pipe, which is submerged in the solution stored in the vessel.

Typically the mixer further includes a gas pipe for supplying gas from the pressurized gas supply to the injection ports.

Typically the gas pipe extends concentrically inside the mixer pipe, the injection ports being defined at a distal end of the gas pipe inside the mixer pipe so that gas is allowed to flow into the mixer pipe via the injection ports.

Typically the foaming chamber is defined in an annulus between the mixer pipe and the gas pipe.

Typically at least one of an internal surface of the mixer pipe and an external surface of the gas pipe includes the shearing structure.

Typically the external surface of the gas pipe includes a helical surface geometry for providing the shearing structure.

Typically the external surface of the gas pipe includes a series of circumferential flutes for providing the shearing structure.

Typically the mixer includes a shearing matrix near the foam outlet.

Typically the system includes a manifold for distributing gas from the pressurized gas supply to the vessel and the injection ports.

Typically the manifold includes:
a) a gas inlet for receiving gas from the pressurized air supply;
b) a first gas outlet for supplying gas to the vessel; and,
c) a second gas outlet for supplying gas to the injection ports.

Typically the manifold includes a pressure relief subsystem for preventing overpressure of the vessel.

Typically the pressure relief subsystem includes at least one of:
a) a pressure relief valve; a bursting disc; and,
b) a check valve.

Typically the manifold includes a depressurizing valve for allowing at least partial depressurization of the vessel.

Typically the depressurizing valve is a needle valve.

Typically the manifold includes a vessel flow valve connected between the pressurized air supply and the vessel for allowing adjustment of a flow of gas supplied to the vessel.

Typically the vessel flow valve is a needle valve.

Typically the manifold includes an injection flow valve connected between the pressurized air supply and the mixer for allowing adjustment of a flow of gas injected into the solution within the mixer.

Typically the injection flow valve is a needle valve.

Typically the manifold is connected to the foam outlet of the mixer and is configured to deliver foam from the foam outlet to a foam dispensing subsystem.

Typically the pressurized gas supply includes at least one of:
a) a compressed gas cylinder;
b) a gas compressor; and,
c) a compressed gas piping system.

Typically the system includes at least one of:
a) a pressure regulator for regulating the pressure of gas supplied from the pressurized gas supply; and,
b) a check valve for allowing one-way flow of gas supplied from the pressurized gas supply.

Typically the system includes a foam dispensing subsystem connected to the foam outlet for dispensing the foam.

Typically the foam dispensing subsystem includes a nozzle connected to the foam outlet using a hose.

Typically the nozzle includes a gas eductor for allowing further gas bubbles to be injected into the foam prior to the foam being dispensed from the nozzle.

Typically the gas eductor includes a cross section reduction within the nozzle and gas inlets for allowing gas to be drawn into the nozzle through the gas inlets.

Typically the nozzle includes a moveable collar that cooperates with the gas inlets to allow the gas inlets to be controllably opened by moving the collar, to thereby control the injection of the further gas bubbles into the foam.

Typically the nozzle includes a shearing filter for shearing the gas bubbles within the foam prior to the foam being dispensed from the nozzle.

Typically the foam dispensing subsystem includes one or more fixed sprinklers connected to the foam outlet via foam delivery piping.

Typically the foam dispensing subsystem includes a time delay valve for diverting fluid from the sprinklers for a predetermined period of time until foam is available to be dispensed from the sprinklers.

Typically the vessel includes a filler tube that extends into the vessel for allowing the vessel to be filled with solution without causing foaming of the solution inside the vessel.

### BRIEF DESCRIPTION OF THE DRAWINGS

An example of the present invention will now be described with reference to the accompanying drawings, in which:

FIG. 1 is schematic circuit diagram of an example of a fire-fighting system;

FIG. 2 is a cross-section view of an embodiment of the fire-fighting system;

FIG. 3A is an isometric view of an example of a manifold and mixer of the first fighting system of FIG. 2;

FIG. 3B is a cross-section view of the manifold and the mixer of FIG. 3A;

FIG. 4 is a cross-section diagram of an example of a foam dispensing nozzle; and,

FIG. 5 is a side view of an example of a gas pipe of the mixer.

### DETAILED DESCRIPTION OF THE PREFERRED EMBODIMENTS

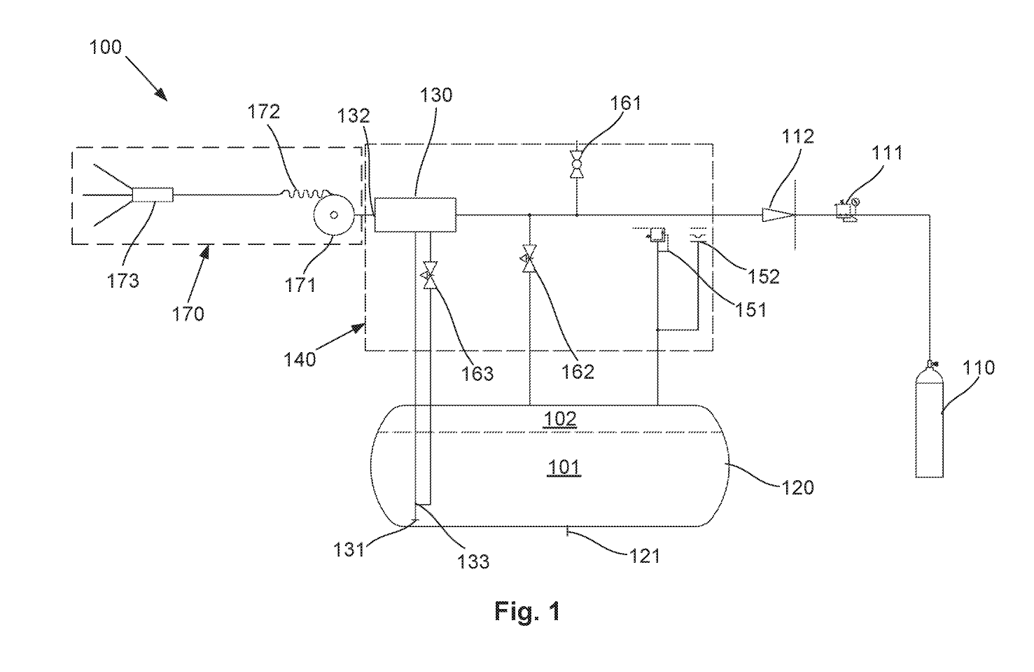

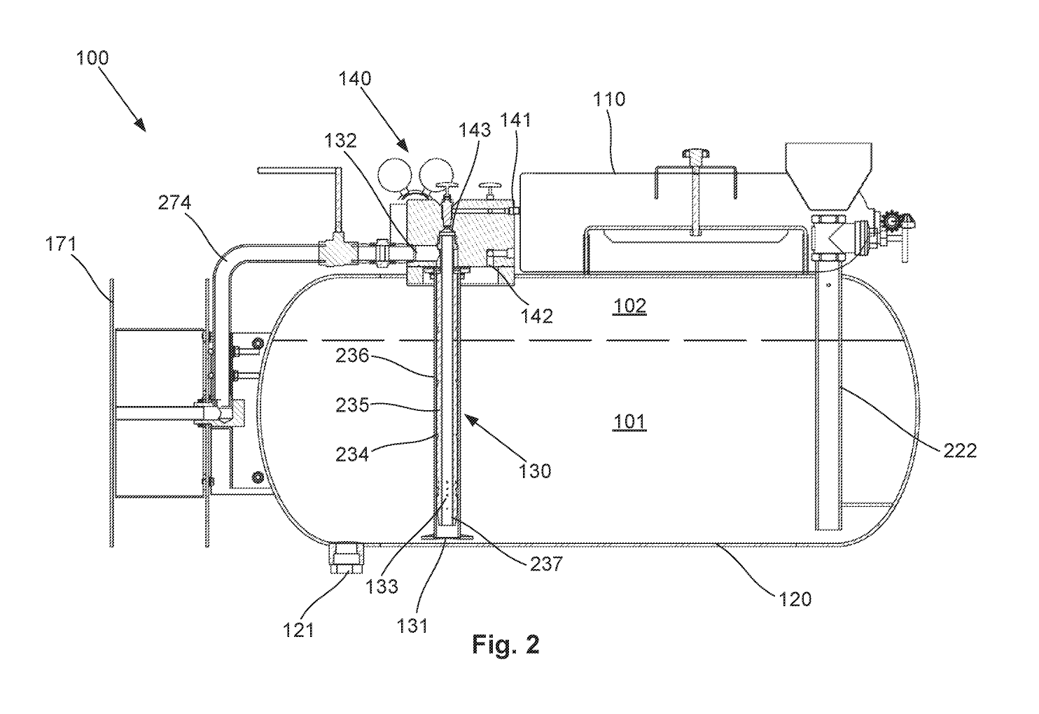

An example of a fire-fighting system 100 will now be described with reference to FIGS. 1 and 2, which respectively illustrate a schematic circuit diagram representation of the system 100 and a cross-section view of an embodiment of the system 100.

In general terms, the fire-fighting system 100 includes a pressurized gas supply 110, a. vessel 120 for storing a solution 101 of water and a foaming agent, the vessel 120 being connected to the pressurized gas supply 110 for pressurizing the vessel 120, and a mixer 130 for mixing gas from the pressurized gas supply 110 with the solution to generate foam.

As can be seen in both FIGS. 1 and 2, the mixer 130 includes a solution inlet 131 for receiving the solution from the vessel 120 and a foam outlet 132. With particular regard to FIG. 2, which shows internal details of the mixer 130, the mixer 130 also includes one or more injection ports 133 connected to the pressurized gas supply 110 for injecting gas bubbles into the solution to form a mixture of the solution and the gas bubbles. Furthermore, the mixer 130 includes a foaming chamber 234 extending between the solution inlet 131 and the foam outlet 132. In use, the mixture flows through the foaming chamber 234 to generate foam at the foam outlet 132. At least one internal surface of the foaming chamber 234 includes a shearing structure 235 for shearing the gas bubbles as the mixture flows through the foaming chamber 234.

By providing the system 100 with a mixer 130 including a foaming chamber 234 having an internal shearing structure 235, the gas bubbles that are injected into the mixture by the injection ports 133 can be sheared into smaller bubble sizes as the mixture flows past the shearing structure 235 along its flow path through the foaming chamber 234. The shearing structure 235 may be selected to induce turbulent flow to thereby agitate or churn the mixture as it flows through the mixer 130. With appropriate selection of the geometry of the shearing structure 235 and characteristics of the mixture and its flow, the mixer 130 can be used to generate fine foam with a homogeneous bubble matrix and consistently sized bubbles.

Although this example refers generally to gas, particularly with regard to the pressurized gas supply 110, the use of gas to pressurize the vessel 120 and the introduction of gas bubbles into the solution within the mixer 130 via the injection ports 133, it will be appreciated that this gas will typically be air, so as to provide an air injected foam system. It should be noted that gas and air will be used interchangeably in the discussion of further examples below, but this should not be taken to imply that only air can be used. It should be appreciated that different gas may be used, such as pure nitrogen or any other suitable gas for forming foams for fire-fighting applications.

The foaming agent may be any suitable composition or mixture of fire-fighting chemicals suitable for generating finely bubbled foam by injecting and mixing bubbles of gas into a solution formed with the foaming agent and water. A range of suitable foaming agents and fire-fighting chemicals are known for use with existing air injected foam or compressed air foam systems. It will be understood that the use of different foaming agents may require tuning of parameters of the system to result in effective fire-fighting foam, depending on differences in the foaming properties or the like. For instance, different foaming agents may require different a solution concentration, a different gas pressure, a different gas:solution ratio of the mixture, or even different geometries of the foaming chamber 234 and its shearing structure 235.

The vessel 120 will typically be a pressure vessel capable of withstanding the pressure of the gas 102 supplied into the vessel 120 from the pressurized gas supply 110. It will be appreciated that the pressurization of the vessel 120 and the solution 101 stored therewithin will cause the solution 101 to be fed into the solution inlet 131 of the mixer 130 due to the pressure of the gas 102. This removes the need for a pump or the like to provide a motive force for causing the solution to flow through the mixer 130. As shown in FIGS. 1 and 2, the vessel 120 may include a drain 121 for allowing the solution to be drained from the vessel 120 as required. With regard to FIG. 2, the vessel 120 may advantageously include a filler tube 222 that extends into the vessel 120 for allowing the vessel 120 to be filled with solution without causing foaming of the solution inside the vessel 120. This can avoid premature aeration of the solution 101 during filling. However, it should be appreciated that the use of a filler tube 222 is not essential.

The pressurized gas supply 110 may be provided using a compressed gas cylinder, a gas compressor, or a compressed gas piping system if already available in fixed location application. In the depicted examples, a compressed gas cylinder is used and it will be appreciated that these can allow for flexible deployment of the system 100 without requiring a separate power supply or fuel source for driving a compressor or the like.

The compressed gas cylinder may be used to store gas at a significantly higher pressure than required for proper operation of the system, and this can allow useful quantities of gas to be stored for use as required. However, in such cases it will be desirable to regulate the pressure of the gas supplied for pressurizing the vessel and injecting gas bubbles into the solution in the mixer 130, at a relatively low pressure compared to the storage pressure. Accordingly, the system may include a pressure regulator 111 for regulating the pressure of gas supplied from the pressurized gas supply as shown in FIG. 1. Furthermore, a check valve 112 may be used to only allow one-way flow of gas from the pressurized gas supply.

In any event, the shearing structure 235 will preferably have a specific geometry designed to exert shearing forces on the mixture for shearing the gas bubbles in an optimised manner for complete mixing of the solution and gas bubbles and consistent generation of foam with desired foam characteristics.

For example, the shearing structure 235 may include roughening or texturing of an internal surface, discontinuities formed in an internal surface or protrusions extending an internal surface of the foaming chamber 234. In the case of surface roughening/texturing, it will be appreciated that this may have an impact on the flow characteristics in the boundary layer adjacent to the surface and may be used to induce turbulent flow within the mixture. In some examples, a ribbed texture may be provided on the surface. Surface discontinuities may be provided, for instance, to induce separation of the flow in the wake of the discontinuities, which may cause the formation of eddies or the like to provide an enhanced mixing effect. Protrusions from the surface may be used to partially obstruct or redirect the flow, which may result in a convoluted flow path of the mixture with flow direction changes which can agitate or churn the mixture components.

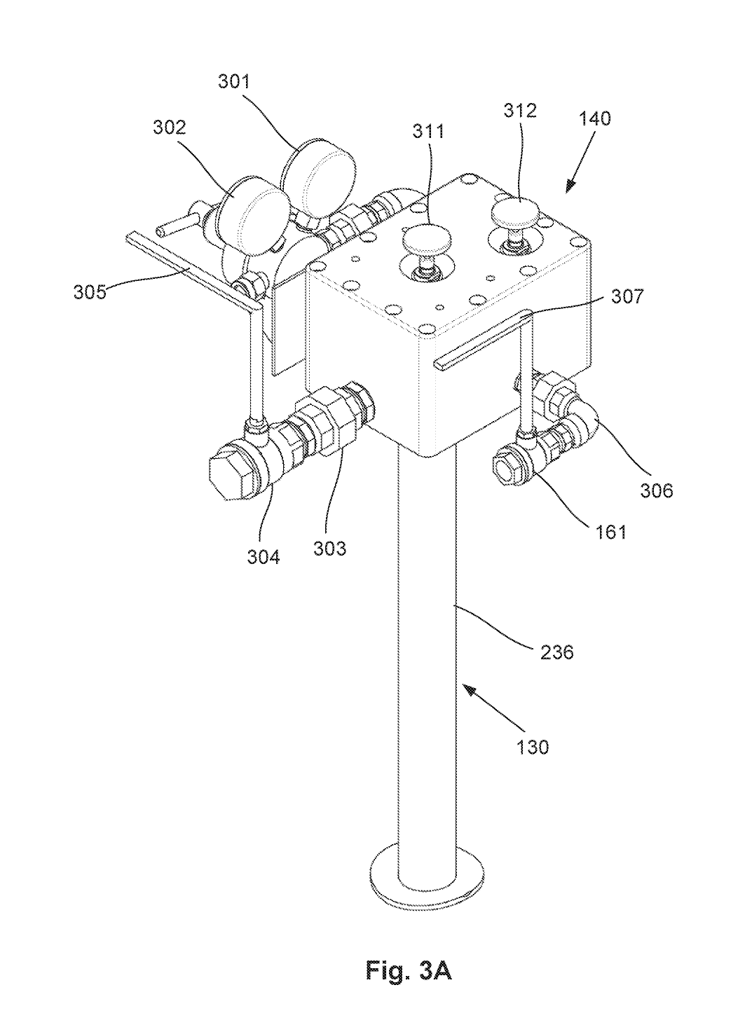

In the example embodiment of the mixer 130 as shown in more detail FIGS. 3A and 3B, it will be seen that the shearing structure includes a repeating pattern of protrusions and surface discontinuities along the foaming chamber 234. Although not clearly discernible in FIGS. 3A and 3B, the surfaces within the foaming chamber may also have a selected surface roughness or a particular texture for further controlling the flow characteristics of the mixture.

In any event, each of these types of shearing structure 235 will typically have an effect of providing increased shearing of the gas bubbles within the mixture, to thereby cause the gas bubbles to be broken into progressively smaller sizes until suitably developed foam is provided at the foam outlet 132.

In preferred embodiments of the mixer 130, the shearing structure 235 may define a series of sub-chambers 304 as shown in FIG. 3B, for causing alternating compression and expansion of the mixture as it flows through the sub-chambers 304. These sub-chambers 304 may be at least partially separated by patterns of protrusions from at least one of the internal surfaces of the foaming chamber 234. The sub-chambers 304 may be configured to define a. particular flow path for the mixture to pass between each sub-chamber 304 while experiencing maximum shearing forces for shearing the gas bubbles.

In some embodiments, the shearing structure 235 may be configured to induce rotational flow of the mixture within the foaming chamber 234. For instance, the shearing structure 235 may include geometries such as protrusions or texturing of the surface which direct the mixture along a rotating flow path through the foaming chamber 234. This may involve providing an internal surface with a generally helical geometry within the foaming chamber 234, although any surface structure for redirecting the flow of the mixture to have an angular velocity component as opposed to a pure axial flow between the solution inlet 131 and the foam outlet 132 will induce at least some rotation flow. In some examples, the shearing structure 235 may be particularly adapted to generate a vortical flow within the foaming chamber 234.

In some embodiments the shearing structure 235 may be configured to change a rotation direction of the mixture as the mixture flows through the foaming chamber 234. It will be appreciated that changes in the flow rotation direction can induce significant agitation of the mixture, particularly where these occur abruptly so as to result in regions of high turbulence rather than relatively smooth transitions of direction. In some examples, these flow rotation direction changes may be conveniently provided at interfaces between sub-chambers of the foaming chamber 234.

The structural arrangement of a preferred embodiment of a mixer 130 is shown in FIG. 2 and in further detail in FIGS. 3A and 3B, and further details of this will now be provided.

In this embodiment, the mixer 130 includes a mixer pipe 236 extending into the vessel 120, with the foaming chamber 234 being providing inside the mixer pipe 236. In particular, the solution inlet 131 is provided at an open end of the mixer pipe 236, which is submerged in the solution 201 stored in the vessel 120. Accordingly, the solution 101 within the pressurized vessel 120 will be forced to flow into the solution inlet 131 under pressure.

The mixer 130 further includes a gas pipe 237 for supplying gas from the pressurized gas supply 110 to the injection ports 133. Although this gas pipe 237 can be run between the pressurized gas supply 110 and the injection ports 133 along any path, a particularly preferred arrangement of the gas pipe 237 is used in the examples shown in Figures.

In particular, in the preferred examples, the gas pipe 237 extends concentrically inside the mixer pipe 236, and the injection ports 133 are defined at a distal end of the gas pipe 237 inside the mixer pipe 236 so that gas is allowed to flow into the mixer pipe 236 via the injection ports 133. The foaming chamber 234 may thus be defined in an annulus between the mixer pipe 236 and the gas pipe 237. This arrangement avoids the need for passing the gas pipe 237 through the mixer pipe 236, which could otherwise impinge on the flow path through the foaming chamber 234 and require complex connections and/or seals.

In such an arrangement, at least one of an internal surface of the mixer pipe 236 and an external surface of the gas pipe 237 includes the shearing structure 235. In this preferred arrangement, the shearing structure 235 is primarily defined on the external surface of the gas pipe 237. This tends to simplify manufacture as it will typically be easier to form the geometries of the shearing structure 235 on an external surface of a pipe using conventional manufacturing techniques such as machining, casting or moulding.

The external surface of the gas pipe 237 may include a helical surface geometry for providing the shearing structure 235. This helical surface geometry may be used to induce a strongly rotating flow within the foaming chamber 234. This helical surface geometry may include protrusions, discontinuities or surface roughening/texturing as discussed above, In particularly preferred forms, the helical surface geometry may include two pitches, one for causing rotational flow of the fluid and another for shearing the mixture as it flows through the foaming chamber.

The geometry of the external surface of the gas pipe 237 at an upstream end of the mixer 130 is preferably shaped to create high fluid velocities as well as shaped to create a vena contracta 321 at the entrance to the annulus. The higher fluid velocity creates a pressure reduction which creates a pressure differential across the gas pipe 237 for driving gas to enter the mixer 130. Likewise the vena contracta 321 also creates a pressure differential driving gas into the foaming chamber 234 within the annulus, via the injection ports 133.

The injection ports 133, which are provided as orifice holes through the gas pipe 237, are positioned to take advantage of both of these effects. In the preferred example there are 6 holes located in the vena contracta 321, and then a further 12 holes located immediately downstream of the exit of the venturi at the entrance. These holes are grouped in 3 sets of 4 holes spaced at approximately 10 mm. The large number of holes creates multiple bubble streams thereby reducing the amount of work required to shear the foam into smaller bubble sizes. The large number of holes also allows a sufficient amount of gas to be driven in to the foaming chamber 234 with a small pressure differential. The holes are positioned close to the upstream end of the foaming chamber 234 to allow for the maximum detention within the foaming chamber 234 and therefore maximum shearing effect.

Although the shearing structure 235 within the foaming chamber 234 may provide foam with adequately sheared gas bubbles mixed homogeneously with the solution, in some examples, the system may include additional shearing elements for causing further controlled shearing of the gas bubbles within the foam prior to the delivery of the foam from the foam outlet 132. For example, the mixer 130 may include a shearing matrix near the foam outlet 132. This shearing matrix may be provided, for instance using a stainless steel wool matrix or at least one fine mesh layer provided in the flow path of the mixture prior to the foam outlet 132. Such a shearing matrix can help to limit the maximum diameter of the gas bubbles and maintain consistent foam characteristics.

In preferred embodiments, the system 100 may further include a manifold 140 for distributing gas from the pressurized gas supply 110 to the vessel 120 and the injection ports 133. The elements provided as part of the manifold 140 and associated flow paths provided within the manifold 140 are indicated by the rectangular area bounded by dashed lines in FIG. 1, and FIGS. 2, 3A and 3B show further details of an example of a manifold 140 for use with the system 100.

With regard to FIG. 2, the manifold 140 may include a gas inlet 141 for receiving gas from the pressurized air supply 110, a first gas outlet 142 for supplying gas to the vessel 120 and a second gas outlet 143 for supplying gas to the injection ports 133 (in this case, via the gas pipe 237 extending concentrically inside the mixer 130 as discussed above). In this example, it should be noted that a hose (not shown) is used to connect the compressed air cylinder providing the pressurized air supply 110 to the gas inlet 141, although details of the hose are obstructed by the cylinder in FIG. 2.

As indicated in the schematic circuit diagram of FIG. 1, the manifold 140 may include a pressure relief subsystem for preventing overpressure of the vessel 110. In this example, the pressure relief subsystem includes a mechanical pressure relief valve 151 for allowing pressure to be controllably released and a bursting disc 152 as a backup measure for allowing pressure to be rapidly released in the event of failure of the pressure relief valve 151 or a significant build up of pressure that cannot be adequately released by the pressure relief valve 151 alone. However, it will be appreciated that alternative implementations of the pressure relief subsystem will not necessarily include the aforementioned elements. For instance, in another example, the pressure relief subsystem may include a pressure relief valve 151 without the backup measure of a bursting disc 152. In other examples, the pressure relief subsystem may additionally or alternatively include a check valve.

As also shown in FIG. 1, preferred embodiments of the manifold 140 may further include valves 161, 162, 163 for allowing control over the flow of gas within the system 100. For example, the manifold 140 may include a depressurizing valve 161 for controlling a flow of gas between the vessel 120 and the environment for allowing at least partial depressurization of the vessel 120. The manifold 140 may include a vessel flow valve 162 connected between the pressurized gas supply 110 and the vessel 120. The vessel flow valve 162 may be provided as a needle valve for allowing fine control over the flow of gas into the vessel 120 from the pressurized gas supply 110, which will in turn have an effect of adjusting the flow of solution from the vessel 120 into the solution inlet 131 of the mixer 130. The manifold 140 may also include an injection flow valve 163 connected between the pressurized gas supply 110 and the mixer 130, for allowing adjustment of the flow of gas injected into the solution within the mixer 130 via the injection ports 133. The injection flow valve 163 may also be provided as a needle valve for allowing fine control over the gas:solution ratio in the mixture formed within the mixer 130. These two flow valves 162, 163 can be operated to adjust the expansion rate of the foam and the overall foam flow rate through the system, which can in turn control how wet/dry the foam will be when generated, and the range of delivery of the foam.

Preferred embodiments of the manifold 140 will also interface with the mixer 130 as shown in the Figures. In particular, the manifold 140 may be coupled to the foam outlet 132 of the mixer 130 and configured to deliver foam from the foam outlet 132 to a foam dispensing subsystem.

With particular regard to FIG. 2, it will be seen that the manifold 140 may be used to close the vessel 120. The mixer pipe 236 and the gas pipe 237 may be attached to an underside of the manifold 140 so that these can extend into the vessel 120 from the manifold 140. The manifold 140 defines internal gas passageways for distributing the gas from the compressed gas supply 110 to the vessel 120 and the mixer 130 via the first and second gas outlets 141, 142. As shown in FIG. 3A, valve interfaces 311, 312 such as handles or knobs may be provided on the manifold 140 for allowing the the operation of the vessel flow valve 162 and the injection flow valve 163, respectively. The manifold 140 may also include pressure gauges 301, 302 for providing visual feedback of the gas pressures in use. Furthermore, the manifold may provide a depressurizing outlet 306 including the depressurizing valve 161 which may be operated by a depressurizing valve lever 307.

The system 100 may include a foam dispensing subsystem 170 connected to the foam outlet 132 for dispensing the foam. The manifold 140 may facilitate this connection between the foam outlet 132 and the foam dispensing system 170. As shown in FIG. 3A, the manifold 140 may also provide a connector 303 including a foam valve 304 operated by a foam valve lever 304, for controlling the flow of foam from the connector 303 to the foam dispensing system 170.

In some examples, particularly for portable or vehicle deployed embodiments of the system 100, the foam dispensing subsystem 170 may include a nozzle 173 connected to the foam outlet 132 using a hose 172. In this case, as seen in FIG. 2, a foam delivery pipe 274 extends from the manifold 140 to connect to a hose reel 171 of the foam dispensing subsystem. The hose reel 171 in turn delivers the foam to the hose 172 and the nozzle 173.

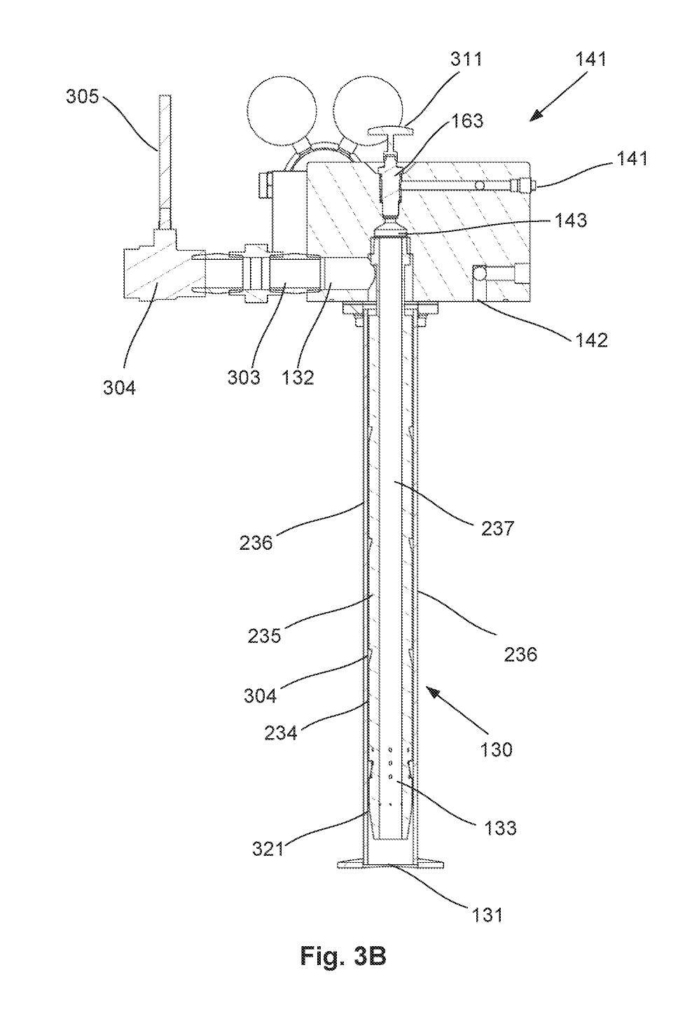

With regard to FIG. 4, which shows an example embodiment of the nozzle 173, the nozzle may include a gas eductor arrangement for allowing further gas bubbles to be injected into the foam prior to the foam being dispensed from the nozzle 173. In particular, the gas eductor may include a cross section reduction within the nozzle 173 (for example, from a first diameter in a foam inlet 401 of the nozzle 173 to a reduced second diameter in an elongated barrel 402 of the nozzle 173) and gas inlets 403 for allowing gas to be drawn into the nozzle 173 through the gas inlets 403. The nozzle 173 may further include a moveable collar 404 that cooperates with the gas inlets 403 to allow the gas inlets 403 to be controllably opened or closed by moving the collar 404, to thereby control the injection of the further gas bubbles into the foam.

Furthermore, the nozzle 173 may include a shearing filter (not shown) for shearing the gas bubbles within the foam prior to the foam being dispensed from the nozzle 173. This shearing filter may be provided as a fine stainless steel mesh filter, and is intended to provide final conditioning of the foam before it is dispensed. This conditioning involves re-shearing the foam bubble structure to ensure a consistent homogeneous gas bubble structure is provided. The location of the steel mesh shearing filter in the nozzle 173 is also to take advantage of the pressure loss along the hose 172 which will cause an expansion of the bubble matrix and in this location the bubbles are the largest size within the system 100. Driving the bubbles through the matrix of the shearing filter at this point provides the opportunity to shear the bubbles further to create the fine foam particularly desirable for dry foam application.

Although the illustrated examples depict a foam dispensing subsystem including a nozzle 173 and hose 172 connection to the manifold 140, to thereby provide a portable fire-fighting system that may be readily deployed and used in a range of circumstances and location, it should be appreciated that the system 100 discussed above may also be used to provide foam for a fixed fire suppression system, such as inside a building, warehouse, factory, aircraft hangar, or any other environment where fire suppression using a foam would be desirable.

In such a fixed fire suppression system embodiment, the foam dispensing subsystem 170 may include one or more fixed sprinklers (not shown) connected to the foam outlet via foam delivery piping (not shown). In this case, the foam dispensing subsystem 170 may include a time delay valve for diverting fluid from the sprinklers for a predetermined period of time until foam is available to be dispensed from the sprinklers. Otherwise, the system 100 may be configured in generally the same manner as discussed above.

In order to highlight other preferred and/or optional features of the system 100, further details of the embodiments illustrated in the Figures will now be described.

Referring again to FIG. 1, it is noted that this shows the general arrangement for embodiments of the system 100 as discussed above. The system 100 includes an arrangement of components as outlined below, which may be scaled to provide fire-fighting systems applicable to a broad range of size, for example having solution capacities ranging from about 9 L through to 10,000 L or greater.

In this case, compressed air cylinders provide the pressurized gas supply 110 at a high pressure and may contain compressed air at pressures up to 3,000 psi. The high pressure compressed air cylinders deliver compressed air to the manifold 140 via a pressure regulator 111 connected to a check valve 112. This arrangement is used to regulate the pressure down to 165-200 psi while protecting the regulator 111 from back flow and pressure. The check valve 112 has a one-way configuration to prevent depressurisation of the mixture storage vessel 120 in the event of disconnection of the pressurized gas supply 110 or failure of the gas supply line between the check valve 112 and the pressurized gas supply 110.

The mixture storage vessel 120 is a pressure vessel capable of withstanding working pressures up to 200 psi. The vessel 120 contains a mixture of water and the chemical required to make the foam.

The manifold 140 performs multiple functions. Primarily, the manifold 140 provides air at working pressure to the vessel 120 to provide the mixing and motive force for the system. Secondarily, the manifold 140 provides an air stream to the mixer 130. The manifold 140 also incorporates the means to depressurize the main vessel 120 via the opening of a de-pressurizing valve 161. Finally the manifold 140 houses the pressure relief system which in the preferred embodiment consists of an overpressure mechanical relief valve 151 and an overpressure burst disc 152.

Within the manifold 140 are two needle valves 162 and 163, which perform the functions of controlling the flow rate of the air to the vessel 120 and to the injection ports 133 of the mixer 130, respectively. This is an important aspect of producing foam of different expansion rates, as well as adjusting the overall foam flow rate.

The manifold 140 effectively provides a structure for attaching the mixer 130, which performs the function of mixing the air and non-aspirated water/foam concentrate mixture in a controlled way to create a consistently small bubble structure.

In particular, the air is supplied at a controlled flow rate to the inner gas pipe 237 of the mixer 130 whereupon it enters the outer mixer pipe 236 within 100 mm from the end of the pipe length from the bottom via a set of small holes, which act as the injection ports 133. The non-aspirated water/foam concentrate mixture is forced up the outer mixer pipe 236 by the pressurizing of the storage vessel 120. The air and non-aspirated water/foam concentrate mixture continue to be forced as a two phase flow along the zone between the inner gas pipe 237 and the outer mixer pipe 236, which in this example is defined as an annulus,

The object of the annulus is to create a foaming chamber that exerts maximum shearing forces on the mixture as it passes the mixer 130 to create a homogenous bubble matrix of approximately 1-2 mm diameter in bubble size. In this example, the outer surface of the inner gas pipe 237 is in contact with this combined liquid/gas mixture and has an engineered geometry to create extreme turbulence, agitation and churning to cause shearing of the bubble interface and create complete mixing of the liquid and air.

In this example, this shearing is achieved, at least in part, by a series of a four sub-chambers which alternate from expansion to compression of the mixture. The surface geometry of the exterior of the inner gas pipe 237 causes the foam flow to spin violently within the annulus. Additionally, the surface geometry of the inner gas pipe 237 has a profile which promotes shearing and turbulence. In the preferred embodiments this surface geometry on the exterior of the inner tube 237 is helical in shape and has two different pitches. One pitch is to cause the fluid to spin and the other is to create a relief in the surface that will shear the fluid as it passes. Over the length of the annulus the mixture is forced to rotate in alternate directions four times. This arrangement can thus generate mixed foam, aerated with fine bubbles. Further shearing and mixing of the aerated foam may be created by the addition of a stainless steel wool matrix located at the top of the annulus.

After leaving the annulus the mixed and sheared foam may be forced through a hose 172 and delivery nozzle 173 as indicated in FIG. 1. A further shearing matrix may be located within the delivery nozzle 173, and in the preferred embodiment this further shearing matrix may be in the form of a fine steel mesh. The object of this mesh is to condition the foam prior to delivery. In this context, conditioning the foam refers to re-shearing the foam bubble structure to ensure a tight homogenous bubble structure is maintained prior to delivery. This location is selected as the system pressure is at the lowest at this point and the bubble size will be the largest, therefore providing the greatest opportunity to shear the bubbles further prior to delivery from the nozzle 173.

Once the mixture leaves the mixer 130 in the chosen foam condition, it is forced through the hose reel 171, via the hose 172 and through the nozzle assembly 173. The nozzle assembly 173 has a final stage air eductor system as will be discussed in detail below.

FIG. 2 shows a practical 200 L embodiment of the system 100, in cross section. This embodiment of the system 100 includes the following arrangement of components.

In particular, this embodiment includes a main vessel 120, containing pressurized gas 102 for pressurizing the water/chemical mix 101. The high pressure input in this embodiment is provided by compressed air cylinders which provide the pressurized gas supply 110, via a regulator into the manifold 140. FIG. 2 shows a pickup tube which provides the mixer pipe 236 and a representative depiction of the internal geometry of the mixer 130. The hose reel 171 is shown coupled to the foam outlet 132 using a foam delivery pipe 274.

This embodiment also contains a novel filler tube 222 with a funnel. This filler tube 222 is provided to fill the vessel 120 from the bottom up so the solution is always being filled from beneath the surface of the solution already in the tank to prevent unnecessary premature frothing of the water/foam chemical solution. A valve seals the filler tube 222 when working under pressure.

FIG. 4 shows an embodiment of a delivery nozzle 173 which may be used with the previously discussed embodiments of the system. This particular example of the nozzle 173 has been designed to allow a delivery range of 30 m to be met.

The hose 172 to be used is 32 mm inner diameter and connects to a foam inlet 401 which subsequently reduces from 32 mm to 25 mm inner diameter in the elongate barrel 402 of the nozzle 173. The flow in the region of this cross-section reduction also passes a small vena contracta within the nozzle 173 and adjacent to this is a collar 404 which can be screwed into a forward position to progressively open small gas inlets 403 formed as holes in the nozzle 173 at the cross-section reduction. Air is drawn from the environment through the holes into the flow by a venturi mechanism. This assembly provides a final stage air inlet to allow adjustment of the expansion of the foam at the nozzle 173. The final component is a long straight barrel 402 of 25 mm inner diameter to accelerate the mixture to sufficient velocity to reach 30 m.

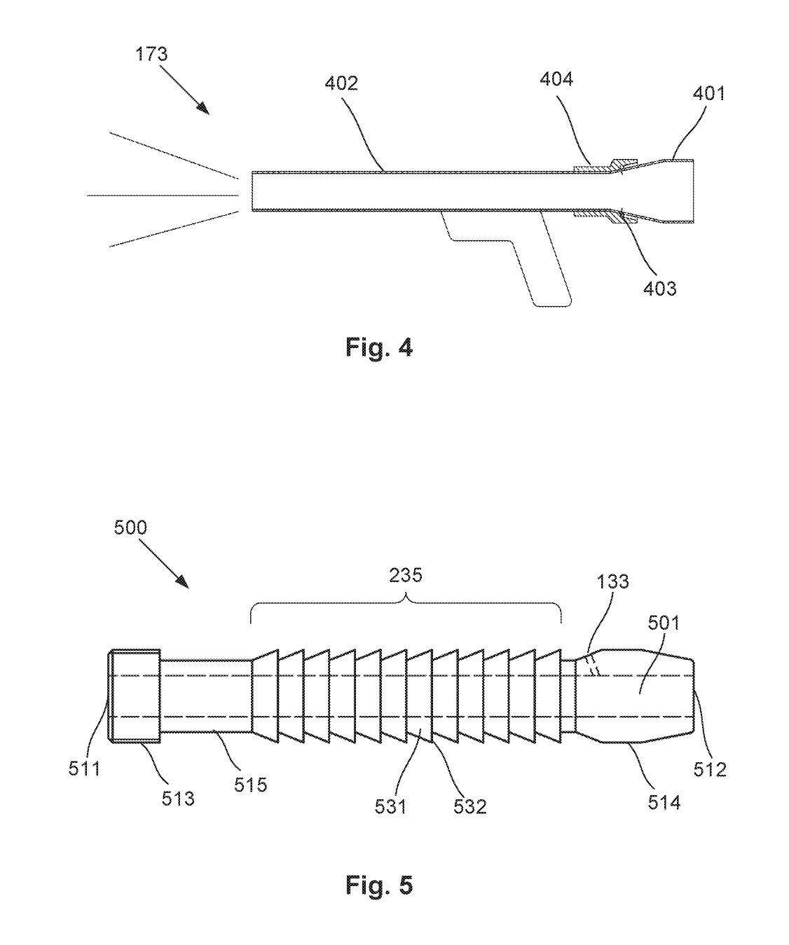

An alternative example of a gas pipe 500 for use in the mixer 130 is shown in FIG. 5. It will be appreciated that the gas pipe 500 of FIG. 5 may replace the previous example of the gas pipe 237 as shown in FIGS. 2, 3A and 3B. The gas pipe 500 mainly differs from the previous example of the gas pipe 237 in the configuration of the shearing structure 235 defined on the outer surface of the gas pipe 500 between first and second ends 511, 512 of the gas pipe 500, and the arrangement of the one or more injection ports 133 near the second end 512.

As per the description above, the gas pipe 500 is included in the mixer 130 of the system 100 and is used to supply gas from the pressurised gas supply 110 to its one or more injection ports 133. The gas pipe 500 includes a central bore 501 extending between the first and second ends 511, 512. Pressurised gas from the pressurised gas supply 110 is supplied to the first end 511 of the gas pipe 500. To enable this, a connecting portion 513 of the gas pipe will typically be defined at the first end 511, and in one example the connecting portion 513 may be threaded for connection to the manifold 140 to allow pressurised gas to be received from the second gas outlet 143 as shown in FIGS. 2 and 3B.

The one or more injection ports 133 are defined in a bulbous portion 514 at the second end 512 of the gas pipe 500. Although only a single injection port 133 is indicated in this example, this is not intended to be limiting and it will be appreciated that a plurality of injection ports 133 may be provided as discussed in previous examples, with the number of injection ports 133 and their particular locations and sizes being selected depending on the requirements for the bubbles to be introduced into the mixer 130 via the injection ports 133.

The bulbous portion 514 cooperates with an internal surface of the outer mixer pipe 236 to define a vena contracta 321 at the entrance to the annulus between the mixer pipe 236 and the gas pipe 500, where the annulus defines the foaming chamber 234 of the mixer 130.

In this example, the shearing structure 235 within the foaming chamber 234 is defined on the outer surface of the gas pipe 500, and involves a series of circumferential flutes 531 protruding from the outer surface of the gas pipe 500. These flutes 531 protrude such that a skirting edge 532 comes into close proximity with the internal surface of the mixer pipe 236 so that only a narrow annulus is defined between each skirting edge 532 and the internal surface. Thus the bubble stream will be sheared as it passes between each narrow annulus along its path through the foaming chamber 234.

Each flute 531 is tapered inwardly from the skirting edge 532 towards the first end 511 of the mixing pipe 500, to thereby define a respective sub-chamber prior to the adjacent flute 531. Thus, the shearing structure 235 defines a series of sub-chambers for causing alternating compression and expansion of the mixture as the mixture flows through the sub-chambers. The number of flutes 531 and their respective sizes may be selected depending on the mixing requirements to ensure that the gas bubbles are sheared and reduced in size to an appropriate degree.

A smooth portion 515 is defined on the outer surface of the gas pipe 500 between the shearing structure 235 and the connection portion 513. In use, this smooth portion 515 will typically be located inside the manifold 140 to coincide with the foam outlet 132 as shown in FIGS. 2. and 3B, to thereby allow the generated foam to be supplied to the foam dispensing subsystem 170.

In any event, it will be appreciated that such a configuration of the gas pipe 500, with appropriately selected geometries of the flutes 531, can be used to generate fine foam by shearing the gas bubbles within the foaming chamber 234 formed between the gas pipe 500 and the mixer pipe 236. However, it should be understood that a range of shearing structures 235 may be used other than the above described flutes 531.

The above discussed arrangements of the system are applicable to air injected foam systems (AIFS) of varying capacities, for application in fire-fighting. These arrangements are particularly suitable for, but not limited to, an ALES system of a type consisting of a compressed air storage tank, a main chemical and water storage pressure vessel, an AIFS mixer and a foam dispensing nozzle or the like.

Preferred embodiments of the system incorporate a specialised mixer which incorporates shearing and mixing actions to create a high expansion, fine bubbled foam. With minor adaptations the arrangements as discussed above can also be used to feed foam concentrate in to a fixed fire suppression system in a building.

Accordingly, the system may provide a family of complete ALES type fire-fighting systems, suitable for a wide range of fire-fighting tasks. The size of the system is likely to range from fire extinguishers of 9 L capacity to large fixed installations of 10,000 L capacity or more.

In preferred embodiments of such systems, the fire-fighting, foam generating chemicals may be pre-mixed into the water storage vessel to increase the effectiveness of the water.

Preferably, embodiments of the system will consistently provide fine bubbled foam through the application of a more efficient mixing/shearing chamber. This chamber will typically include air injector ports, a ribbed surface and surface features for creating rotating flow within the mixer to produce dense, finely bubbled foam.

The system may provide foams of varying types that are suitable for different fire-fighting scenarios. In preferred embodiments, control over the foam consistency may be provided by the incorporation of two needle valves, one on the supply to the mixer tube, which would control the volume of air provided to the mixing chamber, and a second needle valve on the supply side to the vessel. Adjustment of these needle valves affects the foam type and allows dry to wet foam to be generated. The foam type is described as wet or dry, with wet foam having a higher water content and dry foam having a more aerated, lower water consistency.

Embodiments of the system may also advantageously include a filler tube to allow for less turbulence during filling of the main chamber and therefore less foaming of the pre aspirated mixture.

Furthermore, the preferred embodiments of the system may include a foam delivery nozzle which allows the operator to adjust an eductor and increase/decrease the air content of the foam as a final adjustment. Embodiments of the system have been designed to deliver varying density foam i.e. high expansion/low expansion. Preferably, the system will have the ability to deliver the foam at distances up to 30 m.

Embodiments of the system may also include shearing/mixing elements in addition to the shearing/mixing structure in the foaming chamber of the mixer. This may involve providing two zones of filter medium in the flow path of the foam mixture to shear the mixture and create fine bubbled foam.

Preferred embodiments of the system also typically provide a common manifold that performs the following functions:

a) Seals the pressurized main tank containing the pre-mixed fire-fighting fluid;

b) Feeds the main tank with pressurized air;

c) Feeds the mixing chamber with pressurized air;

d) Controls the air feed to the mixing chamber with a needle valve;

e) Controls the air feed to the main vessel with a needle valve;

f) Feeds the foam mixture to the hose reel;

g) Provides a de-pressurization valve; and,

h) Provides a pressure relief valve to protect the main vessel from over pressurization.

In any event, it will be appreciated that embodiments of the system provide beneficial arrangements for generating fire-fighting foam, which may allow better control of the foam consistency compared to conventional systems.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A fire-fighting system including:
a) a pressurized gas supply;
b) a vessel for storing a solution of water and a foaming agent, the vessel being connected to the pressurized gas supply for pressurizing the vessel in use; and, c) a mixer for mixing gas from the pressurized gas supply with the solution to generate foam, wherein the mixer includes:
i) a solution inlet for receiving the solution from the vessel;
ii) a foam outlet;
iii) one or more injection ports connected to the pressurized gas supply for injecting gas bubbles into the solution to form a mixture of the solution and the gas bubbles; and,
iv) a foaming chamber extending between the solution inlet and the foam outlet, the mixture flowing through the foaming chamber to generate foam at the foam outlet, at least one internal surface of the foaming chamber including a shearing structure for shearing the gas bubbles as the mixture flows through the foaming chamber.

2. A system according to claim 1, wherein the shearing structure includes at least one of:
a) roughening of the at least one internal surface;
b) texturing of the at least one internal surface;
c) discontinuities formed in the at least one internal surface; and,
d) protrusions extending from the at least one internal surface.

3. A system according to claim 1, wherein the shearing structure is configured to at least one of:
a) define a series of sub-chambers for causing alternating compression and expansion of the mixture as the mixture flows through the sub-chambers;
b) induce rotational flow of the mixture within the foaming chamber; and
c) change a rotation direction of the mixture as the mixture flows through the foaming chamber.

4-5. (canceled)

6. A system according to claim 1, wherein the mixer includes a mixer pipe extending into the vessel, the foaming chamber being providing inside the mixer pipe.

7. A system according to claim 6, wherein the solution inlet is provided at an open end of the mixer pipe, which is submerged in the solution stored in the vessel.

8. A system according to claim 6, wherein the mixer further includes a gas pipe for supplying gas from the pressurized gas supply to the injection ports.

9. A system according to claim 8, wherein at least one of:
a) the gas pipe extends concentrically inside the mixer pipe, the injection ports being defined at a distal end of the gas pipe inside the mixer pipe so that gas is allowed to flow into the mixer pipe via the injection port; and
b) the foaming chamber is defined in an annulus between the mixer pipe and the gas pipe.

10. (canceled)

11. A system according to claim 9, wherein at least one of:
a) at least one of an internal surface of the mixer pipe and an external surface of the gas pipe includes the shearing structure;
b) the external surface of the gas pipe includes a helical surface geometry for providing the shearing structure; and
c) the external surface of the gas pipe includes a series of circumferential flutes for providing the shearing structure.

12-14. (canceled)

15. A system according to claim 1, wherein the system includes a manifold for distributing gas from the pressurized gas supply to the vessel and the injection ports.

16. A system according to claim 15, wherein the manifold includes:
a) a gas inlet for receiving gas from the pressurized air supply;
b) a first gas outlet for supplying gas to the vessel; and,
c) a second gas outlet for supplying gas to the injection ports.

17. A system according to claim 15, wherein the manifold includes at least one of:
a) a pressure relief subsystem for preventing overpressure of the vessel;
b) a depressurizing valve for allowing at least partial depressurization of the vessel.

18. A system according to claim 17, wherein at least one of:
a) the pressure relief subsystem includes at least one of:
i) a pressure relief valve;
ii) a bursting disc; and,
iii) a check valve and
b) at least one of the depressurizing valve, the vessel flow valve, and the injection flow valve is a needle valve.

19-24. (canceled)

25. A system according to claim 15, wherein the manifold is connected to the foam outlet of the mixer and is configured to deliver foam from the foam outlet to a foam dispensing subsystem.

26-27. (canceled)

28. A system according to claim 1, wherein the system includes a foam dispensing subsystem connected to the foam outlet for dispensing the foam.

29. A system according to claim 28, wherein the foam dispensing subsystem includes a nozzle connected to the foam outlet using a hose.

30. A system according to claim 29, wherein the nozzle includes at least one of:
a) a gas eductor for allowing further gas bubbles to be injected into the foam prior to the foam being dispensed from the nozzle; and
b) a shearing filter for shearing the gas bubbles within the foam prior to the foam being dispensed from the nozzle.

31. A system according to claim 30, wherein at least one of:
a) the gas eductor includes a cross section reduction within the nozzle and gas inlets for allowing gas to be drawn into the nozzle through the gas inlets; and
b) the nozzle includes a moveable collar that cooperates with the gas inlets to allow the gas inlets to be controllably opened by moving the collar, to thereby control the injection of the further gas bubbles into the foam.

32-33. (canceled)

34. A system according to claim 28, wherein the foam dispensing subsystem includes one or more fixed sprinklers connected to the foam outlet via foam delivery piping.

35. A system according to claim 34, wherein the foam dispensing subsystem includes a time delay valve for diverting fluid from the sprinklers for a predetermined period of time until foam is available to be dispensed from the sprinklers.

36. A system according to claim 1, wherein at least one of:
a) the mixer includes a shearing matrix near the foam outlet
b) the system includes at least one of:
i) a pressure regulator for regulating the pressure of gas supplied from the pressurized gas supply; and,
ii) a check valve for allowing one-way flow of gas supplied from the pressurized gas supply;
c) the pressurized gas supply includes at least one of:
i) a compressed gas cylinder;
ii) a gas compressor; and,
iii) a compressed gas piping system; and,
d) the vessel includes a filler tube that extends into the vessel for allowing the vessel to be filled with solution without causing foaming of the solution inside the vessel.
